(19) United States
(12) Patent Application Publication
(10) Pub. No.: US 2026/0342652 A1
(43) Pub. Date: Oct. 29, 2026

(54) NETWORK CONTROLLER AND CONTROL METHOD

(71) Applicant: NTT, Inc., Tokyo (JP)

(72) Inventors: Hiroshi O, Musashino-shi (JP); Tatsuya SHIMADA, Musashino-shi (JP); Kota ASAKA, Musashino-shi (JP)

(73) Assignee: NTT, Inc., Tokyo (JP)

(21) Appl. No.: 19/107,110

(22) PCT Filed: Sep. 7, 2022
(86) PCT No.: PCT/JP2022/033544

§ 371 Date: Feb. 27, 2025

(51) Int. Cl. H04L 41/0823; H04L 41/0816; H04L 43/08

(52) U.S. Cl. CPC H04L 41/0823; H04L 41/0816; H04L 43/08

(57) ABSTRACT

A network controller including: a setting change time acquisition unit that acquires setting change time information indicating a time required to change settings of each of one or more node devices to be controlled; an execution cycle determination unit that determines an execution cycle at which collection of quality information and control of the one or more node devices are performed on the basis of the acquired setting change time information; a quality collection unit that collects quality information from the one or more node devices at the execution cycle determined by the execution cycle determination unit; and an analysis control unit that controls settings of the individual node devices on the basis of the quality information of the individual node devices collected by the quality collection unit at the execution cycle determined by the execution cycle determination unit.

### TECHNICAL FIELD

The present invention relates to a network controller and a control method.

### BACKGROUND ART

In conventional network control based on network quality collection, a network (NW) controller analyzes information on communication quality collected from subordinate NW nodes, and changes settings of the NW nodes on the basis of the analysis results. FIG. 7 is a diagram illustrating a configuration example of a conventional communication system 1000. The communication system 1000 includes one or more NW nodes 1, a NW controller 2, and an operation system 3. The NW controller 2 includes a quality collection unit 4 and an analysis control unit 5.

The quality collection unit 4 collects quality information from the individual NW nodes 1. On the basis of the quality information of the individual NW nodes 1 collected by the quality collection unit 4, the analysis control unit 5 performs analysis of the quality information and setting control of the NW nodes 1 according to the analysis results. At this time, an execution cycle of the processing performed by the quality collection unit 4 and the analysis control unit 5 is generally set in advance by the operation system 3.

### CITATION LIST

### Non Patent Literature

Non Patent Literature 1: Hiroshi Ou, “SLA-aware Real Time Control Technology across Optical and Mobile Networks”, Optical Fiber Communication Conference 2022.

### SUMMARY OF INVENTION

### Technical Problem

An optimal execution cycle for network control depends on setting change time in the NW nodes 1. Specifically, it is desirable that the execution cycle and the setting change time have the same length. As illustrated in FIG. 8, in a case where the execution cycle is longer than the setting change time, an idle time is generated between the completion of a setting change of the NW nodes 1 and the start of the next setting change, and the real-time property is deteriorated accordingly. On the other hand, as illustrated in FIG. 9, in a case where the setting change time is longer than the execution cycle, the NW controller 2 performs the next analysis and control in a state where a setting change of the NW nodes 1 has not been completed, and thus it takes time to perform the control. For example, a setting change-2 illustrated in FIG. 9 cannot be performed immediately after analysis/control processing-2.

As described above, the optimum execution cycle for network control depends on the setting change time in the NW nodes 1, but the setting change time in the conventional network control varies depending on the types and versions of the NW nodes. Therefore, there is a problem that it is not possible to uniquely set the execution cycle and work by operation increases in order to optimize the execution cycle.

In view of the above circumstances, an object of the present invention is to provide a technique capable of reducing work by operation in network control.

### Solution to Problem

An aspect of the present invention is a network controller including: a setting change time acquisition unit that acquires setting change time information indicating a time required to change settings of each of one or more node devices to be controlled; an execution cycle determination unit that determines an execution cycle at which collection of quality information and control of the one or more node devices are performed on the basis of the acquired setting change time information; a quality collection unit that collects quality information from the one or more node devices at the execution cycle determined by the execution cycle determination unit; and an analysis control unit that controls settings of the individual node devices on the basis of the quality information of the individual node devices collected by the quality collection unit at the execution cycle determined by the execution cycle determination unit.

An aspect of the present invention is a control method including: acquiring setting change time information indicating a time required to change settings of each of one or more node devices to be controlled; determining an execution cycle at which collection of quality information and control of the one or more node devices are performed on the basis of the acquired setting change time information; collecting quality information from the one or more node devices at the determined execution cycle; and controlling settings of the individual node devices on the basis of the collected quality information of the individual node devices at the determined execution cycle.

### Advantageous Effects of Invention

According to the present invention, it is possible to reduce work by operation in network control.

### BRIEF DESCRIPTION OF DRAWINGS

FIG. 1 A diagram illustrating a configuration example of a communication system in the first embodiment.

FIG. 2 A flowchart illustrating a flow of execution cycle setting processing performed by a NW controller in the first embodiment.

FIG. 3 A flowchart illustrating a flow of quality collection and control processing performed by the NW controller in the first embodiment.

FIG. 4 A flowchart illustrating a flow of execution cycle setting processing performed by the NW controller in the second embodiment.

FIG. 5 A diagram illustrating a configuration example of a communication system in the third embodiment.

FIG. 6 A flowchart illustrating a flow of execution cycle setting processing performed by a NW controller in the third embodiment.

FIG. 7 A diagram illustrating a configuration example of a conventional communication system.

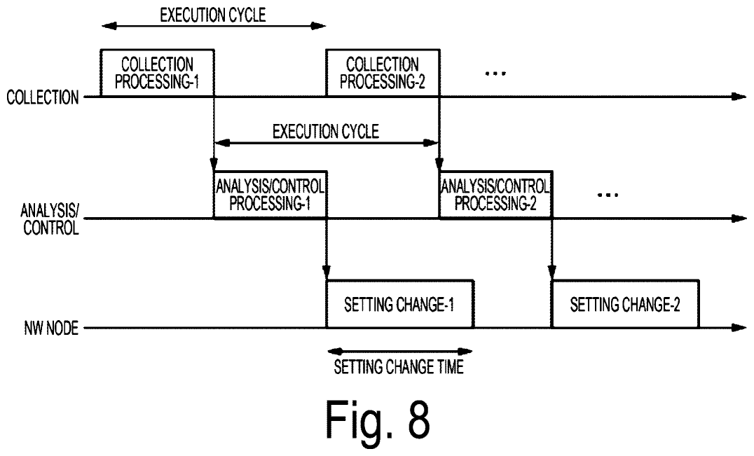

FIG. 8 A diagram for describing a conventional problem. FIG. 9 A diagram for describing a conventional problem.

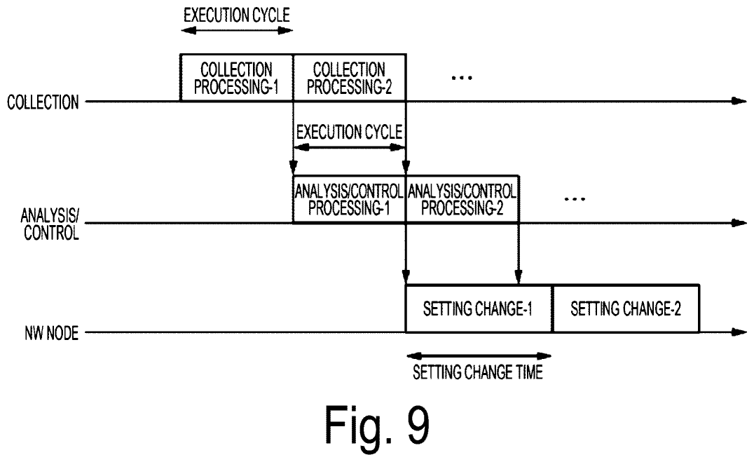

### DESCRIPTION OF EMBODIMENTS

Hereinafter, an embodiment of the present invention will be described with reference to the drawings.

### First Embodiment

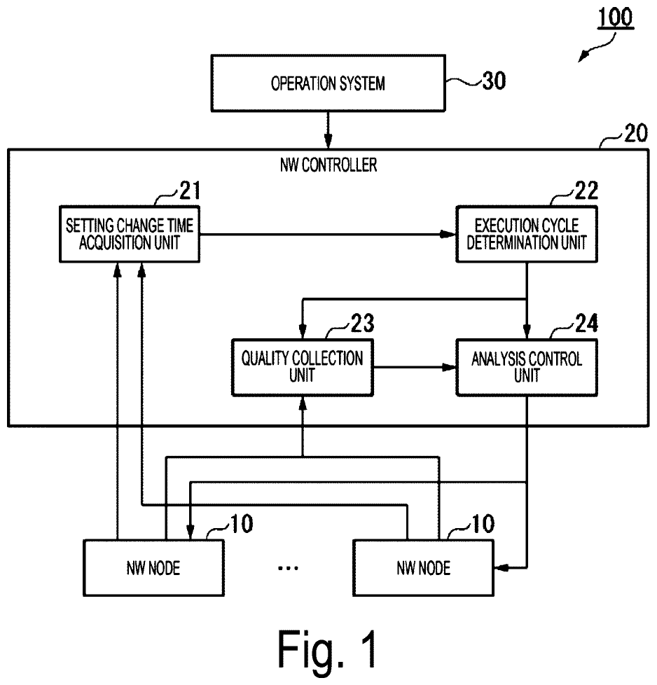

FIG. 1 is a diagram illustrating a configuration example of a communication system 100 in the first embodiment. The communication system 100 includes one or more NW nodes 10, a NW controller 20, and an operation system 30. Connection is made between the one or more NW nodes 10 and the NW controller 20 and between the NW controller 20 and the operation system 30 via transmission paths. The transmission paths may be optical transmission paths such as optical fibers, or may be electric lines such as coaxial cables.

The NW nodes 10 are devices to be controlled by the NW controller 20. The NW nodes 10 operate according to settings of the NW controller 20. The NW nodes 10 may be, for example, transfer devices having an optical switch function and a delay measurement function, devices having an edge computing function instead of the optical switch function, or devices having another communication function. The NW nodes 10 may have a throughput measurement function instead of the delay measurement function. The NW nodes 10 are an aspect of node devices.

Each of the NW nodes 10 reports setting change time information to the NW controller 20 in response to a request from the NW controller 20 or voluntarily at the time of connection to a network of the communication system 100. The setting change time information indicates information regarding a time required to change settings of the NW node 10 (hereinafter, the time is referred to as “setting change time”). The setting change time is a time required from when the NW node 10 receives a control command related to a setting change by the NW controller 20 to when the setting change is completed.

The NW controller 20 is a network controller that acquires setting change time information from the individual NW nodes 10, and determines an execution cycle of collection and analysis control of information regarding communication quality (hereinafter referred to as “quality information”) on the basis of the acquired setting change time information. At the determined execution cycle, the NW controller 20 collects quality information from the individual NW nodes 10 and controls settings of the individual NW nodes 10 on the basis of the collected quality information.

The operation system 30 is a system for controlling the NW controller 20. The operation system 30 is operated by a user. The operation system 30 notifies the NW controller 20 of an instruction according to a user's operation. The operation system 30 is an aspect of a host device.

Next, a configuration of the NW controller 20 will be described. The NW controller 20 includes a setting change time acquisition unit 21, an execution cycle determination unit 22, a quality collection unit 23, and an analysis control unit 24.

The setting change time acquisition unit 21 acquires setting change time information of the individual NW nodes 10 connected to the NW controller 20 for each of the NW nodes 10. Note that the setting change time acquisition unit 21 may acquire the setting change time information of the individual NW nodes 10 from the operation system 30.

The execution cycle determination unit 22 determines an execution cycle at which collection of quality information and control of the individual NW nodes 10 are performed on the basis of the setting change time information of the individual NW nodes 10 acquired by the setting change time acquisition unit 21. Specifically, the execution cycle determination unit 22 determines, as the execution cycle, the maximum time among the maximum time in the setting change time information of the individual NW nodes 10 acquired by the setting change time acquisition unit 21, an execution time required by the quality collection unit 23 for processing (hereinafter, the time is referred to as “collection execution time”), and an execution time required by the analysis control unit 24 for processing (hereinafter, the time is referred to as “control execution time”).

The collection execution time and the control execution time are known information, and are held in advance by the execution cycle determination unit 22. Note that the collection execution time and the control execution time vary according to the number of NW nodes 10 connected to the NW controller 20. Therefore, the execution cycle determination unit 22 holds information regarding the collection execution time and the control execution time for each number of NW nodes 10 connected to the NW controller 20. The information regarding the collection execution time and the control execution time may be acquired by an online measurement of the time actually required for the processing (with the processing performed). As described above, the execution cycle determination unit 22 determines each of the cycle at which the quality information is collected and the cycle at which the individual NW nodes 10 are controlled, but the length of the cycle at which the quality information is collected and the length of the cycle at which the individual NW nodes 10 are controlled are the same.

The quality collection unit 23 collects the quality information from the individual NW nodes 10 at the execution cycle determined by the execution cycle determination unit 22. The quality information collected by the quality collection unit 23 is information used for quality assurance control of the network in real time.

The analysis control unit 24 performs analysis of the quality information and setting control of the NW nodes 10 according to the analysis results on the basis of the quality information of the individual NW nodes 10 collected by the quality collection unit 23 at the execution cycle determined by the execution cycle determination unit 22.

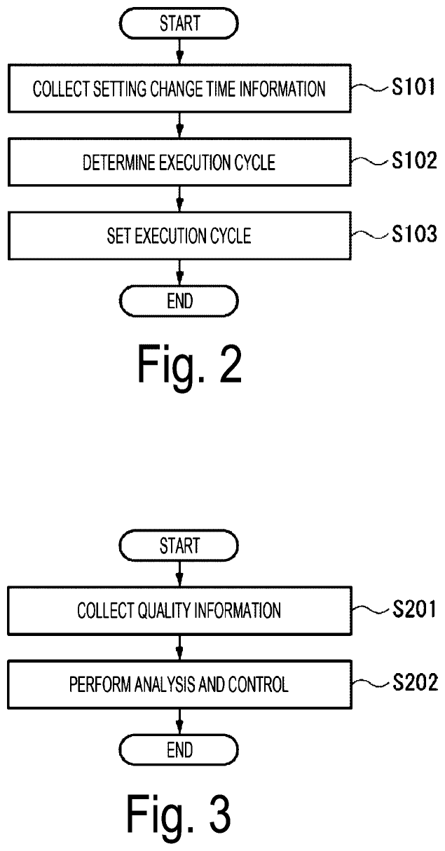

FIG. 2 is a flowchart illustrating a flow of execution cycle setting processing performed by the NW controller 20 in the first embodiment. The execution cycle setting processing illustrated in FIG. 2 is executed at a timing when the NW controller 20 is activated, a timing when a new NW node 10 is connected, or a timing when an instruction from an operator (for example, an instruction from the operation system 30) is received.

The setting change time acquisition unit 21 requests the individual NW nodes 10 connected to the NW controller 20 to report setting change time information. Note that the setting change time acquisition unit 21 may request only the NW node 10 whose setting change time has not yet been grasped by the NW controller 20 to report the setting change time information, or may request all the NW nodes 10 to report the setting change time information. As a result, the NW node 10 that has received the request to report the setting change time information from the NW controller 20 reports the setting change time information to the NW controller 20.

As described above, the setting change time acquisition unit 21 collects the setting change time information of the individual NW nodes 10 connected to the NW controller 20 (step S101).

The setting change time acquisition unit 21 outputs the collected setting change time information of the individual NW nodes 10 to the execution cycle determination unit 22. Note that, in a case where the NW nodes 10 voluntarily report the setting change time information at the time of connection to the NW controller 20, the setting change time acquisition unit 21 may collect the reported setting change time information.

On the basis of the setting change time information of the individual NW nodes 10 output from the setting change time acquisition unit 21, the execution cycle determination unit 22 determines an execution cycle at which collection of quality information and control of the individual NW nodes 10 are performed (step S102). First, the execution cycle determination unit 22 compares the values of the setting change time information of the individual NW nodes 10, the held value of the collection execution time, and the held value of the control execution time. The execution cycle determination unit 22 determines, as the execution cycle, the maximum value obtained as a result of the comparison. For example, when the held value of the collection execution time is the maximum value, the execution cycle determination unit 22 determines the value of the collection execution time as the execution cycle. The execution cycle determination unit 22 sets the determined value of the execution cycle in the quality collection unit 23 and the analysis control unit 24 (step S103).

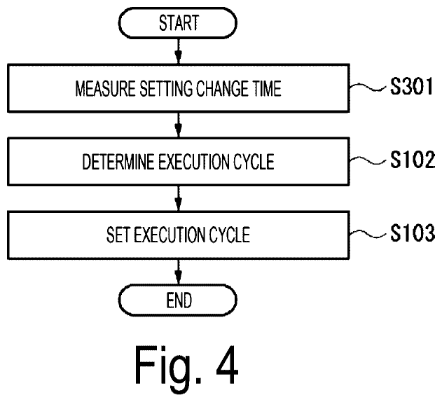

FIG. 3 is a flowchart illustrating a flow of quality collection and control processing performed by the NW controller 20 in the first embodiment. The quality collection and control processing illustrated in FIG. 3 is performed at a timing when the quality collection unit 23 collects quality information. The timing when quality information is collected is preset (for example, every 1 millisecond to 1 second, or the like).

The quality collection unit 23 collects quality information of the individual NW nodes 10 until the period of the execution cycle newly set by the execution cycle determination unit 22 elapses on the basis of the timing when the quality information is collected (step S201). The quality collection unit 23 outputs the collected quality information of the individual NW nodes 10 to the analysis control unit 24. The analysis control unit 24 performs analysis of the quality information of the individual NW nodes 10 output from the quality collection unit 23 and setting control of the NW nodes 10 according to the analysis results until the period of the execution cycle newly set by the execution cycle determination unit 22 elapses on the basis of the timing when the quality information is collected (step S202).

According to the communication system 100 configured as described above, the NW controller 20 includes the setting change time acquisition unit 21 that acquires setting change time information of each of the NW nodes 10 to be controlled, the execution cycle determination unit 22 that determines an execution cycle at which collection of quality information and control of the individual NW nodes 10 are performed on the basis of the setting change time information, the quality collection unit 23 that collects quality information from the individual NW nodes 10 at the execution cycle determined by the execution cycle determination unit 22, and the analysis control unit 24 that controls settings of the individual NW nodes 10 on the basis of the quality information of the individual NW nodes 10 collected by the quality collection unit 23 at the execution cycle determined by the execution cycle determination unit 22. As a result, the execution cycle of the collection and analysis control according to the individual NW nodes 10 connected to the NW controller 20 can be automatically determined and updated. Therefore, high-quality network control can be implemented by low operation work.

The execution cycle determination unit 22 of the NW controller 20 determines, as the execution cycle, the maximum time among the maximum time in the setting change time information of the individual NW nodes 10 acquired by the setting change time acquisition unit 21, the collection execution time, and the control execution time. In a case where one of the setting change of the individual NW nodes 10, the quality information collection processing, and the analysis control processing has not been completed, the processing that has not been completed needs to be waited for. Setting the maximum time as the execution cycle makes it possible to ease the processing performance required for each series of processing while executing high-quality collection processing and analysis control processing.

### Second Embodiment

In the second embodiment, a configuration will be described in which setting change time information is acquired on the basis of a result of measurement between the NW nodes 10 and the NW controller 20. Note that a system configuration of the second embodiment is similar to that of the first embodiment. Hereinafter, differences from the first embodiment will be described.

In the second embodiment, the setting change time acquisition unit 21 measures setting change time in the individual NW nodes 10 between the NW controller 20 and all the NW nodes 10 connected to the NW controller 20. Specifically, first, the setting change time acquisition unit 21 requests the individual NW nodes 10 to change settings, and measures a round trip time (RTT) until a completion response to the request is received from each of the NW nodes 10. The setting change time acquisition unit 21 sets the measured value of the RTT of each of the NW nodes 10 as the setting change time of each of the NW nodes 10.

Note that, in addition to the RTT, the setting change time acquisition unit 21 may measure a round-trip propagation delay time between each of the NW nodes 10 and the NW controller 20 using Ping or the like, and may set a value obtained by subtracting the round-trip propagation delay time from the RTT as the setting change time.

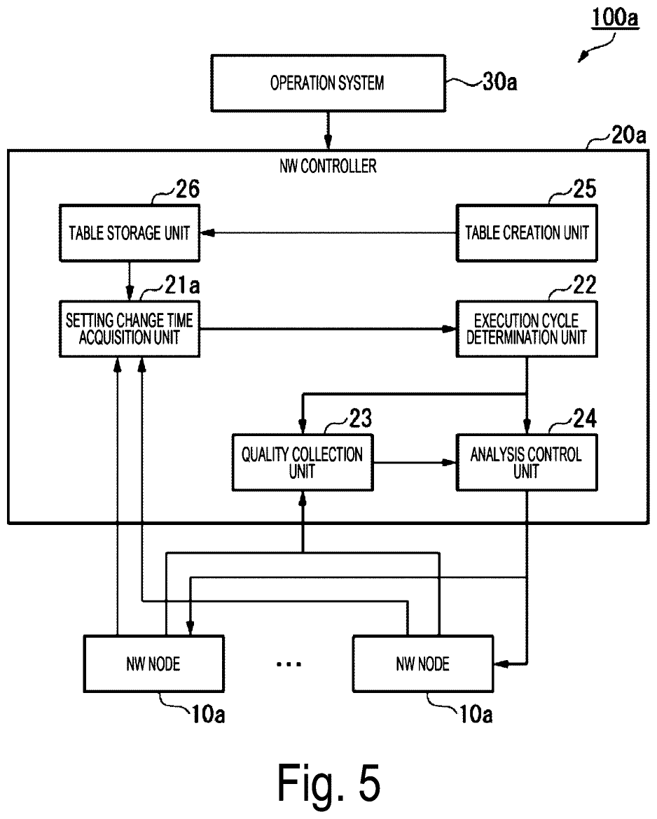

FIG. 4 is a flowchart illustrating a flow of execution cycle setting processing performed by the NW controller 20 in the second embodiment. The execution cycle setting processing illustrated in FIG. 4 is executed at a timing when the NW controller 20 is activated, a timing when a new NW node 10 is connected, or a timing when an instruction from an operator (for example, an instruction from the operation system 30) is received. Note that, in the processing illustrated in FIG. 4, processes similar to those in FIG. 2 are denoted by the same reference numerals as those in FIG. 2, and description thereof is omitted.

The setting change time acquisition unit 21 measures setting change time of the individual NW nodes 10 connected to the NW controller 20 (step S201). For example, the setting change time acquisition unit 21 measures the RTT between each of the NW nodes 10 and the NW controller 20. The setting change time acquisition unit 21 sets the measured value of the RTT of each of the NW nodes 10 as the setting change time of each of the NW nodes 10. The setting change time acquisition unit 21 outputs information on the setting change time of the individual NW nodes 10 based on the measurement results to the execution cycle determination unit 22. Thereafter, the processes in and after step S102 are executed.

According to the communication system 100 in the second embodiment configured as described above, the setting change time acquisition unit 21 acquires the setting change time information on the basis of the result of measuring the RTT and the round-trip propagation delay time between each of the NW nodes 10 and the NW controller 20. As a result, the setting change time information can be acquired by a method different from that of the first embodiment. The NW controller 20 determines the execution cycle on the basis of the setting change time information acquired by the method different from that of the first embodiment, and performs collection of quality information from the individual NW nodes 10 and control of settings of the individual NW nodes 10 based on the collected quality information of the individual NW nodes 10 at the determined execution cycle. As a result, effects similar to those of the first embodiment can be obtained.

### Third Embodiment

In the third embodiment, a configuration will be described in which a NW controller holds setting change time information for each type of NW node and acquires setting change time information according to the types of NW nodes on the basis of the held information.

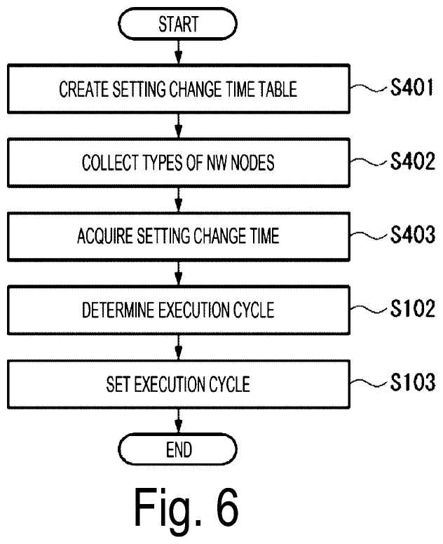

FIG. 5 is a diagram illustrating a configuration example of a communication system 100a in the third embodiment. The communication system 100a includes one or more NW nodes 10a, a NW controller 20a, and an operation system 30a. Connection is made between the one or more NW nodes 10a and the NW controller 20a and between the NW controller 20a and the operation system 30a via transmission paths. The communication system 100a has a configuration different from that of the first embodiment in that the NW nodes 10a, the NW controller 20a, and the operation system 30a are provided instead of the NW nodes 10, the NW controller 20, and the operation system 30. Hereinafter, differences from the first embodiment will be described.

The NW nodes 10a are devices to be controlled by the NW controller 20a. The NW nodes 10a operate according to settings of the NW controller 20a. The NW nodes 10a may be, for example, transfer devices having an optical switch function and a delay measurement function, devices having an edge computing function instead of the optical switch function, or devices having another communication function. The NW nodes 10a may have a throughput measurement function instead of the delay measurement function. The NW nodes 10a are an aspect of node devices.

Each of the NW nodes 10a reports type information to the NW controller 20a in response to a request from the NW controller 20a or voluntarily at the time of connection to a network of the communication system 100a.

The NW controller 20a acquires setting change time information according to the types of the NW nodes 10a from the operation system 30a. The NW controller 20a registers the acquired setting change time information according to the types of the NW nodes 10a in a table, thereby creating a setting change time table. The setting change time table is a table in which the types of the NW nodes 10a and the setting change time information are registered in association with each other. The NW controller 20a acquires type information from the individual NW nodes 10a, and determines an execution cycle on the basis of the acquired type information and the setting change time table. At the determined execution cycle, the NW controller 20a collects quality information from the individual NW nodes 10a and controls settings of the individual NW nodes 10a on the basis of the collected quality information.

The operation system 30a is a system for controlling the NW controller 20a. The operation system 30a notifies the NW controller 20a of the setting change time information according to the types of the NW nodes 10a. The operation system 30a is an aspect of a host device. The setting change time information according to the types of the NW nodes 10a may be acquired by an operator performing pre-verification or the like before laying the network, or in a case where the setting change time information is disclosed in a catalog or the like, the information may be used. As an example of the case where the setting change time information is disclosed in a catalog or the like, the following Reference Literature 1 discloses setting change time information (referred to as “switching time” in Reference Literature 1) of an optical switch of Polatis.

(Reference Literature 1: TOYO Corporation, “Optical layer 1 switch “Polatis 6000n/7000n series””, [online], [Retrieved on Aug. 29, 2022], the Internet<URL: https://www.toyo.co.jp/ict/products/detail/polatis.html>) Next, a configuration of the NW controller 20a will be described. The NW controller 20a includes a setting change time acquisition unit 21a, an execution cycle determination unit 22, a quality collection unit 23, an analysis control unit 24, a table creation unit 25, and a table storage unit 26.

The NW controller 20a has a configuration different from that of the first embodiment in that the setting change time acquisition unit 21a is provided instead of the setting change time acquisition unit 21, and the table creation unit 25 and the table storage unit 26 are further provided. The configuration of the NW controller 20a other than these units is the same as that of the NW controller 20. Therefore, the description of the entire NW controller 20a will be omitted, and the setting change time acquisition unit 21a, the table creation unit 25, and the table storage unit 26 will be described.

The table creation unit 25 acquires setting change time information for each type of NW node 10a from the operation system 30a, and creates a setting change time table using the acquired setting change time information.

The table storage unit 26 stores the setting change time table created by the table creation unit 25. The table storage unit 26 is configured with a storage device such as a magnetic storage device or a semiconductor storage device.

The setting change time acquisition unit 21a acquires setting change time information of the individual NW nodes 10a connected to the NW controller 20a for each of the NW nodes 10a. Specifically, first, the setting change time acquisition unit 21a requests the individual NW nodes 10a connected to the NW controller 20a to report type information. The setting change time acquisition unit 21a acquires the setting change time information of the individual NW nodes 10a for each of the NW nodes 10a on the basis of the type information obtained from the individual NW nodes 10a and the setting change time table stored in the table storage unit 26.

Note that the setting change time acquisition unit 21a may request only the NW node 10a whose type has not yet been grasped by the NW controller 20a to report the type information, or may request all the NW nodes 10a to report the type information. As a result, the NW node 10a that has received the request to report the type information from the NW controller 20a reports the type information to the NW controller 20a. Note that the setting change time acquisition unit 21a may acquire the type information of the individual NW nodes 10a connected to the NW controller 20a from the operation system 30a.

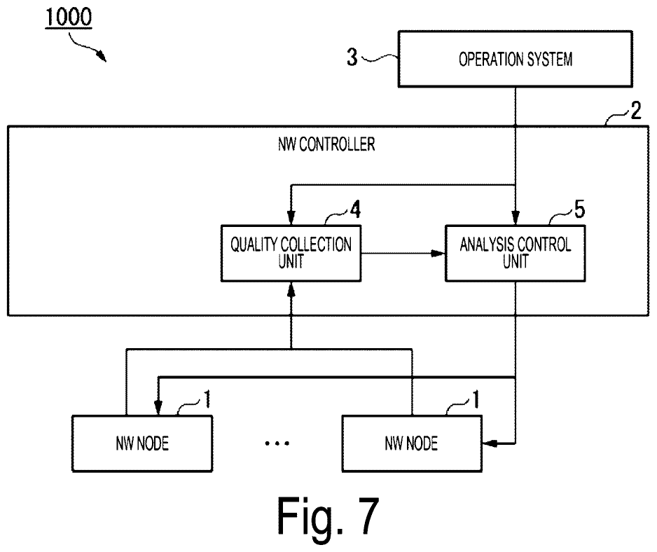

FIG. 6 is a flowchart illustrating a flow of execution cycle setting processing performed by the NW controller 20a in the third embodiment. The execution cycle setting processing illustrated in FIG. 6 is executed at a timing when the NW controller 20a is activated, a timing when a new NW node 10a is connected, or a timing when an instruction from an operator (for example, an instruction from the operation system 30a) is received.

The table creation unit 25 acquires setting change time information for each type of NW node 10a from the operation system 30a. The table creation unit 25 creates a setting change time table using the acquired setting change time information (step S401). Specifically, the table creation unit 25 creates the setting change time table by associating the setting change time information for each type of NW node 10a acquired from the operation system 30a with the types of the NW nodes 10a. The table creation unit 25 stores the created setting change time table in the table storage unit 26.

The setting change time acquisition unit 21a collects type information of the individual NW nodes 10a connected to the NW controller 20a (step S402). The setting change time acquisition unit 21a acquires setting change time information of the individual NW nodes 10a on the basis of the collected type information of the individual NW nodes 10a and the setting change time table stored in the table storage unit 26 (step S403). Specifically, first, the setting change time acquisition unit 21a reads the setting change time table stored in the table storage unit 26. The setting change time acquisition unit 21a then refers to the item of the type in the read setting change time table, and acquires the setting change time information associated with the collected types of the individual NW nodes 10a for each of the NW nodes 10a. The setting change time acquisition unit 21a outputs the acquired setting change time information of the individual NW nodes 10a to the execution cycle determination unit 22. Thereafter, the processes in and after step S102 are executed.

Note that, in a case where the NW nodes 10a voluntarily report the type information at the time of connection to the NW controller 20a, the setting change time acquisition unit 21a may collect the reported type information.

According to the communication system 100a configured as described above, the setting change time acquisition unit 21a acquires the type information from the individual NW nodes 10a, and acquires the setting change time information for each of the NW nodes 10a with reference to the setting change time table on the basis of the acquired type information of the individual NW nodes 10a. As a result, the setting change time information can be acquired by a method different from that of the first embodiment. The NW controller 20a determines the execution cycle on the basis of the setting change time information acquired by the method different from that of the first embodiment, and performs collection of quality information from the individual NW nodes 10a and control of settings of the individual NW nodes 10a based on the collected quality information of the individual NW nodes 10a at the determined execution cycle. As a result, effects similar to those of the first embodiment can be obtained.

### Modification Example of Third Embodiment

In the above-described embodiment, the configuration has been described in which the setting change time acquisition unit 21 a acquires the setting change time information of the individual NW nodes 10a with reference to the setting change time table. The setting change time acquisition unit 21a may be configured to acquire the setting change time information of the individual NW nodes 10a by inquiring the operation system 30a about the setting change time corresponding to the types of the NW nodes 10a instead of referring to the setting change time table. In such a configuration, the NW controller 20a does not have to include the table creation unit 25 and the table storage unit 26. Furthermore, the NW controller 20a does not perform the process of step S401 in FIG. 6. In the process of step S403, the setting change time acquisition unit 21a acquires the setting change time information for each of the NW nodes 10a by inquiring the operation system 30a about the setting change time corresponding to the collected types of the individual NW nodes 10a.

With such a configuration, it is not necessary to create the setting change time table in the NW controller 20a. As a result, the processing load of the NW controller 20a can be reduced.

Some or all of the functional units of the above-described NW controllers 20 and 20a are implemented as software by a processor such as a central processing unit (CPU) executing a program stored in a storage device having a non-volatile recording medium (non-transitory recording medium). The program may be recorded in a computer-readable non-transitory recording medium. The computer-readable non-transitory recording medium is, for example, a non-transitory recording medium such as a portable medium such as a flexible disk, a magneto-optical disk, a read only memory (ROM), or a compact disc read only memory (CD-ROM) or a storage device such as a hard disk built in a computer system.

Some or all of the functional units of the above-described NW controllers 20 and 20a may be implemented with hardware including an electronic circuit (or circuitry) using, for example, a large scale integrated circuit (LSI), an application specific integrated circuit (ASIC), a programmable logic device (PLD), a field programmable gate array (FPGA), or the like.

Although the embodiments of the present invention have been described above in detail with reference to the drawings, specific configurations are not limited to the embodiments, and include design and the like within a range not departing from the gist of the present invention.

### INDUSTRIAL APPLICABILITY

The present invention can be applied to a communication system that collects quality information of a network.

### REFERENCE SIGNS LIST

10, 10a NW node
20, 20a NW controller
30, 30a Operation system
21, 21a Setting change time acquisition unit
22 Execution cycle determination unit
23 Quality collection unit
24 Analysis control unit
25 Table creation unit
26 Table storage unit
100, 100aCommunication system

1. A network controller comprising:
a setting change time acquirer configured to acquire setting change time information indicating a time required to change settings of each of one or more node devices to be controlled;
an execution cycle determiner configured to determine an execution cycle at which collection of quality information and control of the one or more node devices are performed on a basis of the acquired setting change time information;
a quality collector configured to collect quality information from the one or more node devices at the execution cycle determined by the execution cycle determiner; and
an analysis controller configured to control settings of each of the one or more node devices on a basis of the quality information of each of the one or more node devices collected by the quality collectorcollection at the execution cycle determined by the execution cycle determiner.

2. The network controller according to claim 1, wherein
the setting change time acquirer acquires the setting change time information by a notification from a host device, a request to the one or more node devices, or a voluntary report from the one or more node devices.

3. The network controller according to claim 1, wherein
the setting change time acquirer acquires the setting change time information on a basis of a result of measurement between the network controller and the one or more node devices.

4. The network controller according to claim 1, wherein
the setting change time acquirer further acquires information regarding types of the one or more node devices, and acquires the setting change time information by referring to a table in which the setting change time information is associated with each type of node device or inquiring a host device about setting change time corresponding to the types of the node devices on a basis of the acquired information regarding the types of the one or more node devices.

5. The network controller according to claim 4, further comprising
a table creatorcreation configured to create the table by acquiring setting change time information for each type of node device and registering the setting change time information in association with each type of node device by use of the acquired setting change time information.

6. The network controller according to claim 1, wherein
the execution cycle determiner determines, as the execution cycle, a maximum time among a maximum time in the setting change time information acquired by the setting change time acquireracquisition an execution time required by the quality collector for processing, and an execution time required by the analysis controller unit for processing.

7. A control method comprising:
acquiring setting change time information indicating a time required to change settings of each of one or more node devices to be controlled;
determining an execution cycle at which collection of quality information and control of the one or more node devices are performed on a basis of the acquired setting change time information;
collecting quality information from the one or more node devices at the determined execution cycle; and
controlling settings of each of the one or more node devices on a basis of the collected quality information of each of the one or more node devices at the determined execution cycle.
